(19) United States
(12) Patent Application Publication
(10) Pub. No.: US 2009/0157871 A1
(43) Pub. Date: Jun. 18, 2009

(54) Information Processing Apparatus and Wireless Connection Service Availability Notification Method

(75) Inventor: Prabandana Listyanto, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/244,614

(22) Filed: Oct. 2, 2008

(30) Foreign Application Priority Data
Dec. 14, 2007 (JP) 2007-323943

(51) Int. Cl. G06F 15/173

(52) U.S. Cl. 709/224

(57) ABSTRACT

According to one embodiment, an information processing apparatus includes a display device, an operation button, a wireless modem, and a control module. The control module determines, when the operation button is operated, wireless connection service availability in accordance with whether or not the wireless modem allows communication with a base station which forms a wireless connection service area and accommodates a mobile station within the wireless connection service area in a network, and displays the determination result on the display device.

### CROSS-REFERENCE TO RELATED APPLICATIONS

This application is based upon and claims the benefit of priority from Japanese Patent Application No. 2007-323943, filed Dec. 14, 2007, the entire contents of which are incorporated herein by reference.

### BACKGROUND

1. Field

One embodiment of the invention relates to a user interface technique for notifying a user of the availability of wireless connection services applied to an information processing apparatus such as a personal computer.

2. Description of the Related Art

In recent years, personal computers including a wireless communication function have widely prevailed. Along with this, various types of wireless connection services called hot spot services provide areas within which a personal computer including a wireless connection function can connect to the Internet. When the user carries a personal computer, such as a notebook type computer, which can be driven by a battery, he/she can connect to the Internet in such area, and check new email messages or browse Web pages, even if he/she is away from home.

In the hot spot service, a base station (access point: AP) that forms a wireless connection service area as a wireless LAN (Local Area Network) environment is located in each area, and relays between the Internet and mobile stations (personal computers including a wireless communication function) within the wireless connection service area. Along with the widespread use of such wireless LAN, various techniques associated with wireless LAN systems have been proposed (see, e.g., Jpn. Pat. Appln. KOKAI Publication No. 2006-60336).

Assume that a user who subscribes to a wireless connection service and carries a notebook computer with a wireless communication function wants to connect to the Internet when he/she is away from home or on the move. In this case, the user opens the display (cover) of the notebook computer to turn on the power supply of the computer body, and attempts to connect to the Internet using the wireless connection service.

If the place where the user is located is outside the wireless connection service area formed by the base station, all the operations of opening the display (cover) of the notebook computer to turn on the power supply of the computer body, and attempting to connect to the Internet using the wireless connection service are in vain. That is, there has been a strong demand for a mechanism which allows the user to know the availability of wireless connection services by a simpler procedure.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view of an information processing apparatus according to an embodiment of the invention in a state in which a display unit is opened, when viewed from the front side;

FIG. 2 is an exemplary perspective view of the information processing apparatus of the embodiment in a state in which the display unit is closed, when viewed from the front side;

FIG. 3 is an exemplary block diagram showing the internal hardware configuration of the information processing apparatus of the embodiment;

FIG. 4 is an exemplary schematic view for schematically explaining the wireless connection service availability notification mechanism of the information processing apparatus of the embodiment;

FIG. 5 is an exemplary view showing an example of wireless connection service availability recorded in a register of an EC/KBC of the information processing apparatus of the embodiment by a wireless communication environment list display module as firmware of the EC/KBC;

FIG. 6 is an exemplary view showing a display switching operation of a sub display, which is executed by the wireless communication environment list display module as firmware of the EC/KBC of the information processing apparatus of the embodiment when a user presses a wireless communication environment check button; and

FIG. 7 is an exemplary flowchart showing the procedure of processing associated with wireless connection service availability notification executed by the information processing apparatus of the embodiment.

### DETAILED DESCRIPTION

Various embodiments according to the invention will be described hereinafter with reference to the accompanying drawings. In general, according to one embodiment of the invention, an information processing apparatus includes a display device, an operation button, a wireless modem, and a control module. The control module determines, when the operation button is operated, wireless connection service availability in accordance with whether or not the wireless modem allows communication with a base station which forms a wireless connection service area and accommodates a mobile station within the wireless connection service area in a network, and displays the determination result on the display device.

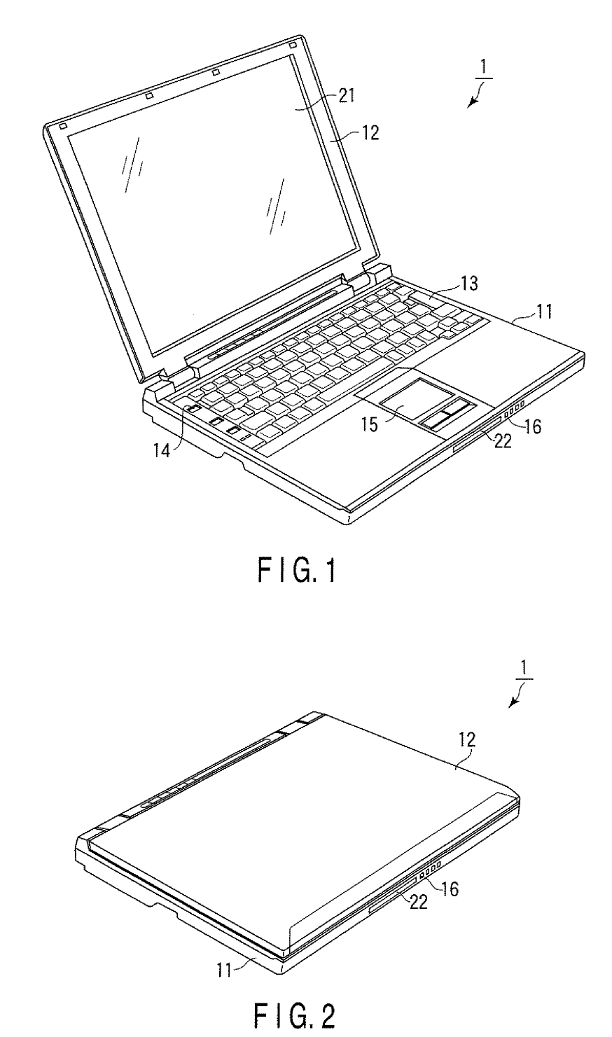

The configuration of an information processing apparatus according to the embodiment will be explained with reference to FIG. 1 and FIG. 2. The information processing apparatus is implemented as a notebook type computer 1 which can be driven by a battery.

FIG. 1 is an exemplary perspective view of the computer 1 in a state in which a display unit (cover) is opened, when viewed from the front side.

The computer 1 comprises a computer body 11 and display unit 12. The display unit 12 incorporates a display device including an LCD (Liquid Crystal Display) 21, the display screen of which is located almost at the center of the display unit 12.

The display unit 12 is supported by the computer body 11, and is attached to the computer body 11 to be pivotal between the open position where the upper surface of the computer body 11 is exposed and the closed position where the upper surface is covered. The computer body 11 has a thin-box-shape housing, on which a keyboard 13, a power button 14 for turning on/off the power supply of the computer 1, a touchpad 15 and the like are arranged. A wireless communication environment check button 16 and sub display 22 (to be described later) are arranged on the front surface of the computer body 11.

FIG. 2 is an exemplary perspective view showing the outer appearance of the computer 1 in a state in which the display unit 12 is closed. As shown in FIG. 2, the wireless communication environment check button 16 and sub display 22 arranged on the front surface of the computer body 11 are exposed even in a state in which the display unit 12 is closed. The user, therefore, can operate the wireless communication environment check button 16 and see the sub display 22 in the state (shown in FIG. 2) without opening the display unit 12. The arrangement positions of the wireless communication environment check button 16 and sub display 22 are not limited to the front surface of the computer body 11. They can be arranged at any position on the computer 1 (including the rear surface of the display unit 12), which is exposed even in the state in which the display unit 12 is closed.

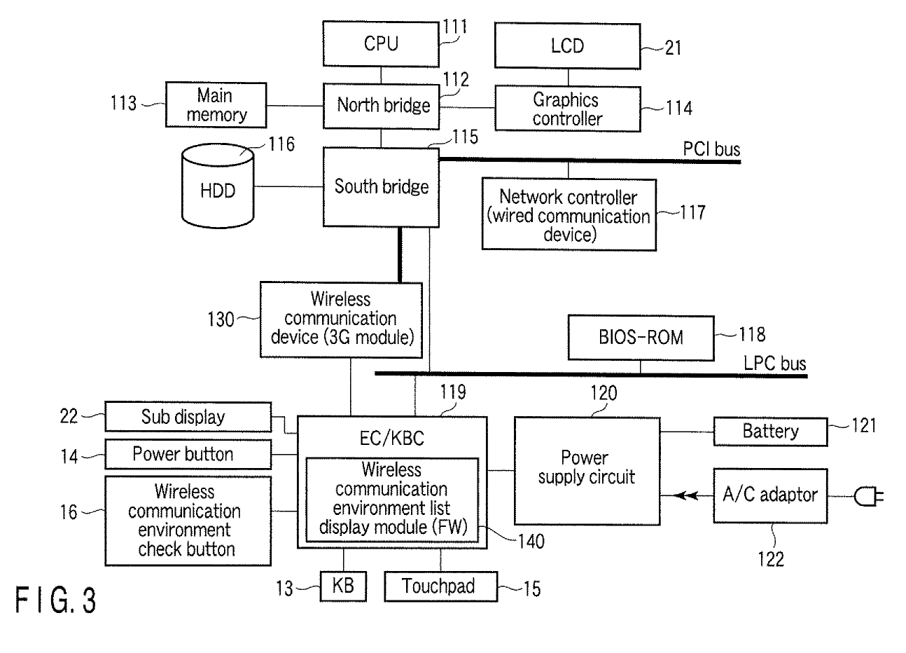

FIG. 3 shows the internal hardware configuration of the computer 1.

As shown in FIG. 3, the computer 1 includes a CPU 111, north bridge 112, main memory 113, graphics controller 114, south bridge 115, hard disk drive (HDD) 116, network controller 117, BIOS (Basic Input/Output System)-ROM 118, embedded controller/keyboard controller IC (EC/KBC) 119, power supply circuit 120, and wireless communication device 130.

The CPU 111 is a main processor which controls the operation of the computer 1. The CPU 111 executes an operating system and various application programs/utility programs, which are loaded from the HDD 116 to the main memory 113. The CPU 111 also executes a BIOS stored in the BIOS-ROM 118. The BIOS is a program for controlling the hardware.

The north bridge 112 is a bridge device which interconnects a local bus of the CPU 111 and the south bridge 115. The north bridge 112 has a function of executing communications with the graphics controller 114 via an accelerated graphics port (AGP) bus or the like. The north bridge 112 also incorporates a memory controller which controls the main memory 113.

The graphics controller 114 is a display controller which controls the LCD 21 used as the display monitor of the computer 1. The south bridge 115 has a function of controlling various devices connected to a peripheral component interconnect (PCI) bus and a low pin count (LPC) bus. The south bridge 115 also incorporates an IDE controller which controls the HDD 116.

The network controller 117 is a communication device which executes communications with external apparatuses via a wired LAN.

The EC/KBC 119 is a one-chip microcomputer on which an embedded controller for power management and the keyboard controller for controlling the keyboard (KB) 13, touchpad 15, and the like are integrated. The EC/KBC 119 cooperates with the power supply circuit 120 to turn on/off the power supply of the computer 1 in accordance with the user operation of the power button 14. The EC/KBC 119 holds a wireless communication environment list display module 140 (to be described later) as firmware (FW).

The power supply circuit 120 generates operation power to be supplied to each component of the computer 1, using a battery 121 or external power supplied via AC adaptor 122. Even when the computer 1 is in a power off state, the power supply circuit 120 continues supply of the operation power to the EC/KBC 119, sub display 22, and wireless communication device 130.

The wireless communication device 130 is a wireless modem which executes wireless communication with the base station in accordance with a wireless communication standard such as a 3G Wireless WAN (Wide Area Network) standard, and is connected to the south bridge 115 via a PCI Express bus or USE bus. The 3G Wireless WAN is a wireless wide area network such as a cellular phone network. The wireless communication device 130 is also connected with the EC/KBC 119 via a dedicated line.

The computer 1 which mounts the wireless communication device 130 serving as a wireless modem can use a wireless connection service called a hot spot service. The computer 1 has a mechanism which allows the user to know, by a simple procedure, whether the computer is in an environment where the wireless connection service is available. This will be explained in detail below.

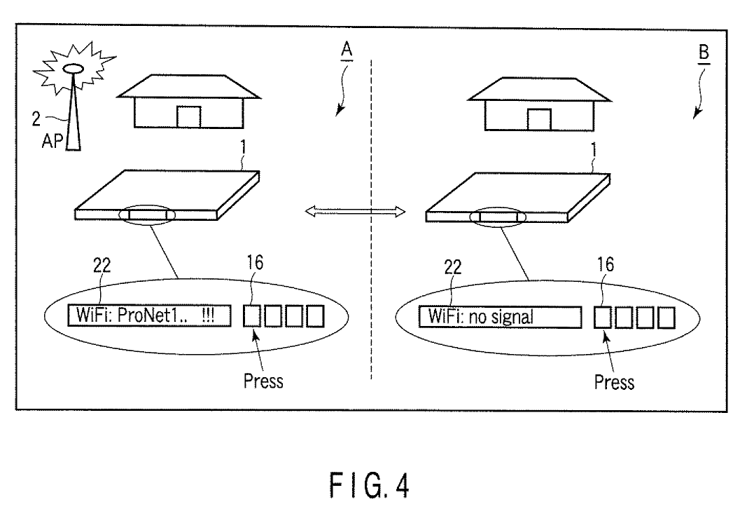

First, a brief description of the wireless connection service availability notification mechanism of the computer 1 will be given with reference to FIG. 4.

Referring to FIG. 4, reference symbol “A” denotes an environment where it is possible to use a wireless connection service to which the user of the computer 1 subscribes, i.e., a situation where the computer is in a wireless connection service area formed by a base station (access point: AP) 2. The computer 1 is in a power-off state. In this situation, when the user presses the wireless communication environment check button 16 arranged on the front surface of the computer body 11, the EC/KBC 119 which is supplied the operation power from the power supply circuit 120 even in the power off state detects the operation of pressing the wireless communication environment check button 16.

Upon detecting that the user presses the wireless communication environment check button 16, the wireless communication environment list display module 140 held as firmware in the EC/KBC 119 causes the wireless communication device 130, which is supplied the operation power from the power supply circuit 120 even in the power-off state, to search for a base station 2. It is determined based on the search result whether the computer is in the wireless connection service area formed by a base station 2, i.e., whether the computer is in an environment where the wireless connection service is available. The wireless communication environment list display module 140 therefore displays, on the sub display 22 which is supplied the operation power from the power supply circuit 120 even in the power off state, the fact that the wireless connection service is available (since a base station 2 is found in this situation).

On the other hand, reference symbol “B” denotes an environment where it is impossible to use the wireless connection service to which the user of the computer 1 subscribes, i.e., a situation where the computer is outside the wireless connection service area formed by a base station (access point: AP) 2. The computer 1 is in a power-off state. In this situation, when the user presses the wireless communication environment check button 16 arranged on the front surface of the computer body 11, the wireless communication device 130 cannot find any base station 2. The wireless communication environment list display module 140, therefore, displays a message representing that the wireless connection service is unavailable.

Assume that the user wants to connect to the Internet when he/she is away from home or on the move. In this case, the user can know whether the computer is in a place where it is possible to connect to the Internet simply by pressing the wireless communication environment check button 16 arranged on the front surface of the computer body 11 (in a state in which the computer 1 is in a power off state) without having to open the display unit 12, press the power button arranged on the upper surface of the computer body 11 to set the computer 1 to a power on state, and attempt to connect to the Internet using the wireless connection service.

It is therefore possible to check that the computer is not in the situation “B” of FIG. 4 but in the situation “A” of FIG. 4 by using a simple procedure. This makes it possible to open the display unit 12, press the power button arranged on the upper surface of the computer body 11 to set the computer 1 to a power on state, and attempt to connect to the Internet using the wireless connection service only in the situation “A” of FIG. 4.

Upon detection that the user presses the wireless communication environment check button 16, if base stations 2 for a plurality of wireless connection services are found, the wireless communication environment list display module 140 stores the search result. It is possible to determine the hot spot service type on the basis of SSID information acquired from each base station 2.

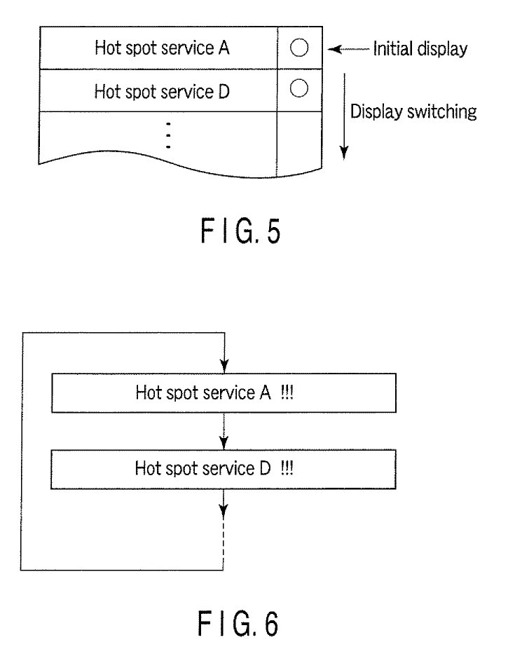

The EC/KBC 119 is provided with a register for storing the search result. The wireless communication environment list display module 140 records, in the register, the result of searching for base stations 2, i.e., available wireless connection services. FIG. 5 shows an example of the available wireless connection services recorded in the register by the wireless communication environment list display module 140.

The wireless communication environment list display module 140 records the plurality of available wireless connection services in the register, and then displays, on the sub display 22, a message representing that a wireless connection service stored in the first entry of the register is available. The wireless communication environment list display module 140 switches the display target of the sub display 22 to a wireless connection service stored in a next entry every time an operation of pressing the wireless communication environment check button 16 is detected. That is, as shown in FIG. 6, the user can check on the sub display 22 that “hot spot service A” is available by pressing the wireless communication environment check button 16, and can further check that “hot spot service D” is available by subsequently pressing the wireless communication environment check button 16 again. The user, therefore, can readily check whether the wireless connection service to which the user subscribes is available.

Note that if it is not detected over a predetermined period that the user presses the wireless communication environment check button 16 again, the wireless communication environment list display module 140 ends the information display on the sub display 22.

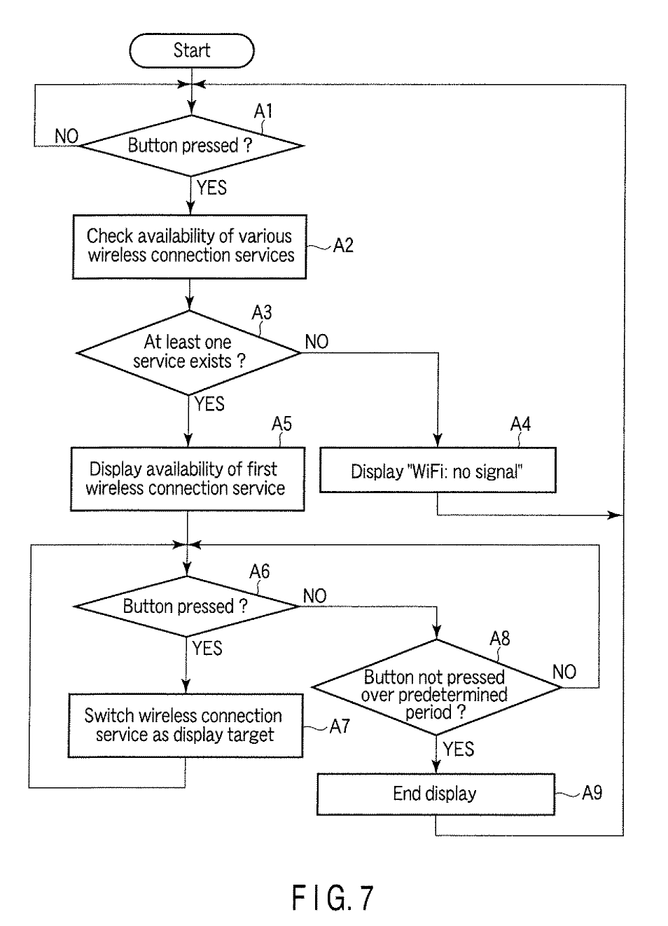

FIG. 7 is an exemplary flowchart showing the procedure of processing associated with wireless connection service availability notification executed by the computer 1.

Upon detecting that the user presses the wireless communication environment check button 16 (YES in block A1), the wireless communication environment list display module 140 of the EC/KBC 119 which is supplied the operation power from the power supply circuit 120 even in the power-off state causes the wireless communication device 130, which is supplied the operation power from the power supply circuit 120 even in the power-off state, to search for base stations 2, and checks the availability of various wireless connection services (block A2). If no base station 2 is found (NO in block A3), the wireless communication environment list display module 140 displays, on the sub display 22 which is supplied the operation power from the power supply circuit 120 even in the power-off state, the fact that no wireless connection service is available (block A4).

If at least one base station 2 is found (YES in block A3), the wireless communication environment list display module 140 displays on the sub display 22 the fact that the first wireless connection service on the list is available (block A5).

Subsequently, if it is detected that the user presses the wireless communication environment check button 16 again (YES in block A6), the wireless communication environment list display module 140 switches the display target, representing an available service, of the sub display 22 to a wireless connection service next to that which is currently displayed as an available service on the sub display 22 (block A7). If it is not detected over a predetermined period that the user presses the wireless communication environment check button 16 again (No in block A6 and YES in block A8), the wireless communication environment list display module 140 ends the display of the wireless connection service availability on the sub display 22 (block A9).

As described above, the computer 1 allows the user to know the wireless connection service availability by a simpler procedure.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a display device;
an operation button;
a wireless modem; and
a control module configured to determine, when the operation button is operated, wireless connection service availability in accordance with whether or not the wireless modem allows communication with a base station which forms a wireless connection service area and accommodates a mobile station within the wireless connection service area in a network, and to display the determination result on the display device.

2. The information processing apparatus of claim 1, the apparatus comprising a main body and a cover which is attached to the main body to be pivotal between an open position where an operation surface of the main body is exposed and a closed position where that operation surface is covered,
wherein the display device and the operation button are arranged on a part of the main body which is exposed even when the cover is in the closed position.

3. The information processing apparatus of claim 1, the apparatus comprising a power supply circuit which supplies operation power to each unit and controls the power supply,
wherein the power supply circuit continues supply of the power to the display device, the wireless modem, and the control module even when the information processing apparatus is in a power off state.

4. The information processing apparatus of claim 1, wherein the control module displays, on the display device, each of a plurality of wireless connection services determined as available services.

5. The information processing apparatus of claim 4, wherein the control module switches an available wireless connection service as a display target of the display device every time the operation button is operated, after determining the wireless connection service availability upon the operation of the operation button.

6. A wireless connection service availability notification method of an information processing apparatus which includes a display device, an operation button, and a wireless modem, the method comprising:
determining, when the operation button is operated, wireless connection service availability in accordance with whether the wireless modem allows communication with a base station which forms a wireless connection service area and accommodates a mobile station within the wireless connection service area in a network; and
displaying the determination result on the display device.
